(19) United States
(12) Patent Application Publication
(10) Pub. No.: US 2022/0165173 A1
(43) Pub. Date: May 26, 2022

(54) SMOKE OPACITY FIELD CERTIFICATION TESTING METHOD

(71) Applicant: ARTHUR H. EBERLE, HARVEST, AL (US)

(72) Inventor: ARTHUR H. EBERLE, HARVEST, AL (US)

(21) Appl. No.: 17/102,637

(22) Filed: Nov. 24, 2020

(51) Int. Cl. G09B 9/00; G09B 5/02

(52) U.S. Cl. CPC G09B 9/00; G09B 5/02

(57) ABSTRACT

The method disclosed herein is utilized to educate and test students seeking field certification to be certified as a qualified observer for smoke opacity, including compliance with EPA method 9 certification. The method allows a user to train and test on their cell phone, electronic notebook, laptop, or other electronic device. The method allows immediate generation of test results, provides user feedback, incorporates whether the user is wearing glasses, incorporates the users orientation and distance to the smoke stack, and incorporates atmospheric conditions affecting opacity observation.

This invention is titled “Smoke Opacity Field Certification Testing Method”. The Smoke Opacity Field Certification Testing Method was invented by Arthur H. Eberle, a resident of the United States, with the following residence address: 2916 Old Railroad Bed Road, Harvest, Alabama 35749.

### CROSS-REFERENCE TO RELATED APPLICATIONS

This application does not claim priority to any prior-filed application.

### DISCLOSURE REGARDING PRIOR DISCLOSURES BY THE INVENTOR OR A JOINT INVENTOR

The inventor has not disclosed this invention more than twelve months prior to the filing of a provisional application to which priority is claimed.

### BACKGROUND OF THE INVENTION

### (1) Field of the Invention

The U.S. Environmental Protection Agency and state agencies regulate air quality and particulate emissions resulting from processes. The EPA has promulgated Method 9 to detect when emitters are in compliance with EPA guidelines. Method 9 states that emission levels are determined by having qualified observers determine the opacity of emissions. Method 9 states that to be qualified observers must be tested twice annually to maintain field certification. The test includes fifty questions wherein an observer determines the opacity of particulate matter or emissions.

The method disclosed herein is utilized to educate and test individuals seeking field certification, including EPA method 9 certification. The method incorporates the following: whether the individual testing is wearing glasses or corrective lenses, the orientation and distance of the individual in relation to the source of visible particulate matter, and the direction of the source of visible particulate matter to the individual.

### (2) Disclosure of the Prior Art

There are a number of devices and methods disclosed in the prior art for adaptive training systems and for determination of air quality, but no prior art discloses the invention herein. Falash et al. (U.S. Pat. No. 10,685,582 B2) discloses an adaptive training system, method and apparatus. The invention of Falash et al. employs a simulation station that displays output to a student and receives input. The computer system has a rules engine that stores learning object data including learning objects configured to provide interaction with a student at the simulation system, and rule data defining a plurality of rules accessed by the rules engine. The invention includes output of one of the learning objects so as to interact with the student. The device of Falash et al. comprises an immersive station with sensors for gaze, touch, speech and haptics that are not utilized in this invention.

Gong et al. (U.S. Pat. No. 9,740,967 B2) discloses a method and apparatus for determining air quality comprising acquiring a reference clear image, a training image under poor air quality and corresponding actual air quality index in at least one location of the key area. A machine learning algorithm is used to obtain a corresponding function or model between differences of features and air quality indices as the trained model. The extracted air quality related features comprise at least one of luminance, chrominance, texture and gradient density. Then the air quality related features may be extracted. For example, the feature of luminance may be embodied as a histogram feature of a luminance distribution map, and detailed extraction step may comprise transforming RGB color value of a pixel into luminance value by using a mathematical equation. This extraction process may be modified for the other named air quality indices. This method and apparatus could not be used in Method 9 training and testing for air quality.

Liu et al. (U.S. Pat. No. 10,302,613 B2) discloses a computer-implemented method and a system for adapting a model for estimating a concentration of particulate matter in the atmosphere including obtaining image data, humidity data and actual particulate matter concentration data. The method comprises obtaining traffic camera data and humidity sensor data, which are revised with normalize features. Particulate matter monitor training data is utilized with the normalized data features to perform machine learning to train model. This method is limited because it only addresses the effects of humidity, or haze, on air quality/particulate matter concentration.

Frankland et al. (U.S. Pat. No. 9,542,686 B2) discloses a system for managing changes in regulatory and non-regulatory requirements for business activities at an industrial or commercial facility. The system provides one or more databases that contain information on operations and requirements concerning an activity or area of business, receives information on regulatory and non-regulatory changes that affect operations of the business, converts these changes into changes in data entry forms, data processing and analysis procedures, and presentation of data processing and analysis results to selected recipients, and implements receipt of change information.

Currently, all field certification testing is graded manually. There are unique aspects of field certification testing that make manual grading time consuming, difficult, and complex. A method of EPA method 9 certification field testing is needed to simplify testing and enable a quicker turnaround of results to test takers. Additionally, current methods require the trainee/test taker to interact physically with an instructor or operator, including but not limited to, exchange of paperwork, registration and registration documents, and grading. During the current COVID-19 pandemic, a method that allows training and/or testing without contact between users and the instructor or operator is necessary.

Current methods are unable to verify location of the trainee or user during smoke opacity registration and testing. At this time, a user could take a test for another who may not be present during the test, and it would be unknown to the operator. A method of instantly identifying the user and the user's location will assist in reducing fraud in the certification testing process.

### BRIEF SUMMARY OF THE INVENTION

The method disclosed herein allows a user with a smart device with an internet connection, such as a handheld cell phone or tablet, to take the Method 9 certification test electronically. Additionally, the method can be used for training purposes to train or education a user how to determine smoke opacity pursuant to Method 9. The testing and/or training is conducted outside in the field. An Operator oversees the testing and/or training and is responsible for ensuring that a smoke generator that emits test smoke is performing correctly. The Operator also ensures that opacity levels are correctly logged for each smoke opacity reading. And, the Operator ensures that the users testing or training are implementing the method herein.

### BRIEF DESCRIPTION OF THE DRAWINGS

The invention is described in detail below with reference to the appended drawings. FIGS. 1 through 6 depict the Smoke Opacity Field Certification Testing Method. In the Figures:

FIG. 1 is a flow chart depicting a user's login and set up procedure.

FIG. 2 is a flow chart depicting testing or training point operations.

FIG. 3 is a flow chart illustrating the validation and certification of a user's filed certification data.

FIG. 4 shows an illustrative example of the method displayed on a handheld electronic device prior to testing or training.

A screen shot of a handheld electronic device wherein a user is selecting an opacity level for a first smoke sample is shown in FIG. 5.

FIG. 6 shows a screen shot of a handheld electronic device wherein a user is selecting an opacity level for a 3^{rd} smoke sample is shown in FIG. 6.

### DETAILED DESCRIPTION OF THE INVENTION

While this invention is susceptible of embodiment in many different forms, there are shown in the drawings and will herein be described in detail, several embodiments with the understanding that the present disclosure should be considered as an exemplification of the principles of the invention and is not intended to limit the invention to the embodiments so illustrated. Further, to the extent that any numerical values or other specifics of materials, etc., are provided herein, they are to be construed as exemplifications of the inventions herein, and the inventions are not to be considered as limited thereto.

The following description and drawings are illustrative and are not to be construed as limiting. Numerous specific details are described to provide a thorough understanding of the disclosure. However, in certain instances, well-known or conventional details are not described in order to avoid obscuring the description. References to one, or an embodiment in the present disclosure, can be, but not necessarily, references to the same embodiment; and, such references mean at least one of the embodiments.

Reference in this specification to “one embodiment’ or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same term can be said in more than one way.

Consequently, alternative language and synonyms may be used for any one or more of the terms discussed herein, or is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

Training and testing for Method 9 field certification comprises an Operator that manages a smoke generator that has been equipped with a smoke meter installed to measure opacity across the diameter of the smoke generator stack. The smoke meter output displays instack opacity based upon a path length equal to the stack exit diameter, on a full 0 to 100 percent chart recorder scale.

During training and testing, the Operator shows a user black and white smoke plumes of smoke of known opacity value that have been generated by a smoke generator. The user assigns an opacity value to each plume and records his observation using the method herein. During testing, a user is shown 25 black plumes and 25 white plumes. Opacity values are assigned in 5 percent increments. A user can not pass the certification test if an error in assigning opacity values exceeds 15 percent opacity on a single reading. The average error of a user may not exceed 7.5 percent opacity for black plumes and for white plumes of smoke.

Testing and training may be conducted outside where the Operator is operating a smoke generator in view of one or more users. The users are students that are training in the field or individuals being tested for field certification. During training or testing the Operator manipulates the smoke generator to produce smoke at a certain opacity level. The Operator must record the opacity level of each smoke plume generated.

This method allows training or testing that is contactless, without contact between the user and the Operator. This method allows the user to register and complete all training and/or testing without having any contact with another. This means that large numbers of users spread at least six feet apart could participate in testing and/or training without risk of contracting COVID-19 or another virus.

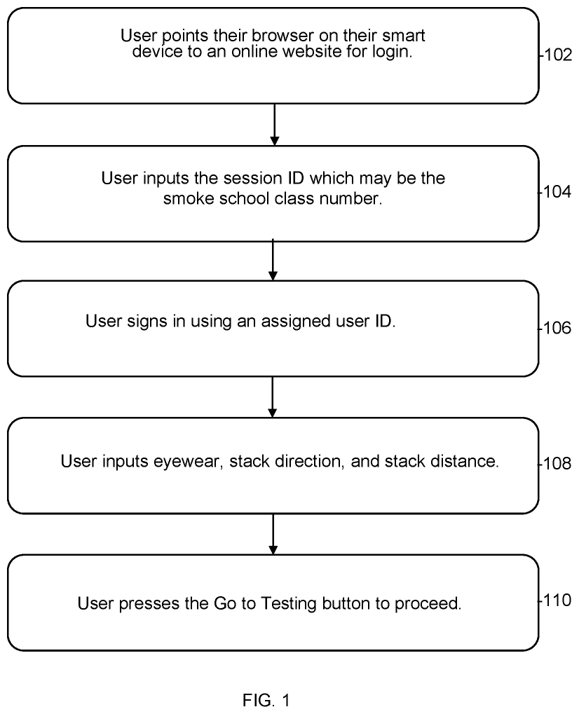

FIG. 1 depicts a flow chart depicting a user's login and set up procedure. A user must have an internet-connect smart device, such as a cell phone or electronic tablet. The user opens their browser at 102 and goes to the internet website wherein they can login. The user then inputs a session ID at 104. The session ID associates the user training or testing with the Operator conducting the session. The user logins in at step 106. This may comprise the user signing in with an assigned student number, a session ID identifying the particular training and or testing that the user is participating in.

Next, at step 108, the user may input whether he is wearing eyewear, such as glasses or contacts, the direction of the smoke stack from the user's current location, the direction that the smoke stack is to the user, the distance that the smoke stack is from the user, the height of the user, the current temperature, wind direction, whether the air is hazy, foggy, overcast, sunny, or clear. A user's location and the direction (East, West, North, Southeast, Northeast, Southwest, and Northwest) of the smoke stack from the user can affect the user's perception of plume smoke opacity. The user's distance from a smoke stack can affect their observation of the smoke plume emitted. And, the opacity level of smoke plumes can be affected by temperature, wind direction, haze, fog, and overcast or clear skies. The method herein incorporates these factors.

The method may be configured so that the when the user electronically interfaces with the method, the method will compute the user's distance and direction from the smoke stack once the Operator has brought the smoke stack online. This allows the method to incorporate these factors automatically while the user is training or testing. The entry of a user's distance and direction allows the method to calibrate a user's answers so that differences of distance and direction are factored into the scoring system utilized for each test point.

At step 110, the user starts training or testing by pressing “Go”, “Start”, or other button to begin the method on user's electronic device. Practice test points may be included so that the method is able to calibrate a user's answers with the Operator's entered data. Users are scattered throughout a testing area. Due to Covid-19, user's must be a minimum of six feet in distance. This requires a large area to be utilized in order to have significant numbers of users testing and/or training at the same location at the same time which spreads the users out at a distance further from the smoke stack than pre-Covid-19. A user that is 50 feet from the smoke stack may perceive the opacity level of the smoke emitted differently from a user that is 100 feet from the smoke stack. A method of differentiating between user perception based on user positioning during the certification test is needed.

Differences in the user's perception of smoke opacity due to distance and direction may be calibrated and utilized by the method when scoring the user's answers. For example, if the user's perception due to distance and direction causes a 5 percent reduction in smoke opacity perception, then the method can calibrate the user's answers so that the Operator's inputed correct answer is reduced by 5 percent for the particular user, while maintaining the Operator's inputed correct answer for other users. This allows each test given to be adapted to each user despite the presence of numerous users at any given test.

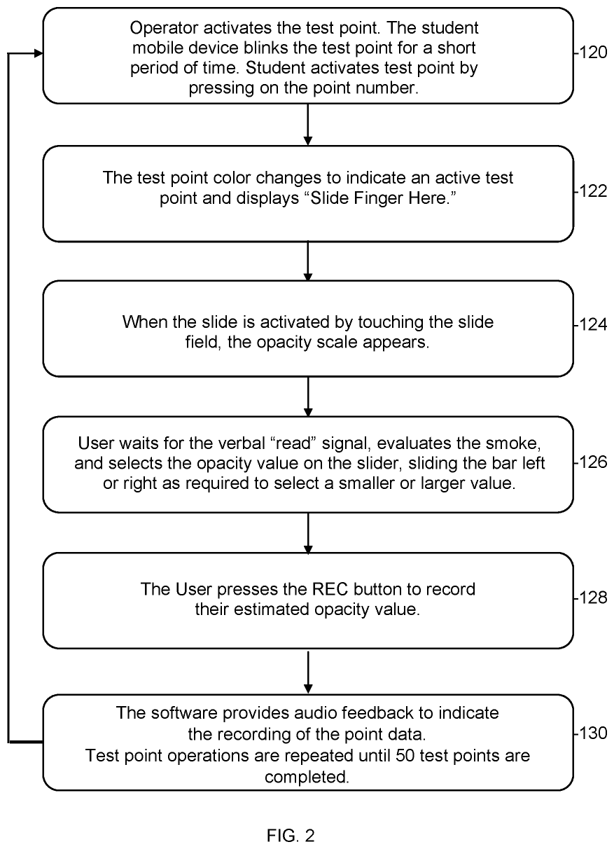

FIG. 2 depicts a flow chart of point operations for training and testing. At step 120, the Operator activates the test point wherein a plume of smoke is released from the smoke generator. The first test point is the point wherein the Operator activates the first plume of smoke. The smoke generator includes a smoke meter that measures the smoke opacity level. The information from the smoke meter may be transmitted via internet to a server wherein data from the Operator and the user is stored and analyzed. The second test point is the point wherein the Operator causes the second plume of smoke to be emitted from the smoke generator. The Operator electronically records the opacity level of each test point plume of smoke. The opacity level is communicated via internet to a server. The server is coupled to a computer so that data received from the Operator is stored and processed. The user enters his answer onto his electronic device. Answers and data from the user is transmitted via server from the user's electronic device. This allows the Operator to monitor student answers so that the Operator can provide feedback, and allows the Operator to correct any errors in the testing method. For example, if users positioned West of the smoke stack encounter perception issues such that the opacity is unclear, the Operator monitoring user input can stop the test, repeat problem test points, and may re-position certain users so that the perception issues are corrected.

Often a user changes his or her answer to a test point. This change may be confusing on a paper answer sheet. Sometimes, users mark through or erase their first answer, and enter a 2^{nd} or 3^{rd} answer. The method herein provides clear and unequivocal answers that a user may not dispute.

At step 122, the Operator activation of a test point is transmitted to the electronic device of the user. The screen of the electronic device may indicate an active test point. A number of screen interface designs may be contemplated. Disclosed herein is one screen interface layout, but many variations may be employed. The screen of the user's electronic device may display a prompt, such as a bubble displaying “Slide Finger Here”. This prompt informs the user that a smoke plume is being generated. This method allows the user's electronic device to be locked so that only the test point being generated may be answered by the user. This prevents a user from skipping a test point. Since the test is usually administered outside and the users may be a significant distance from the Operator and the smoke generator, a user may miss hearing a test point causing significant missed answers, skipping a line or putting two marks on a line. All are eliminated by this method.

Additionally, this method may include a timing function wherein the user is provided a certain time limit to record an answer to a test point. If a user fails to record an answer to a test point, then the Operator knows immediately that the user has failed to answer. That user can be given a 2^{nd} test point to compensate for the missed answer. Additionally, the user may record an answer after a long delay from the smoke release, indicating that they may not have seen the full smoke release. This method allows the Operator to generate a test point for a particular user while preventing others from participating in the particular test point.

This method allows the Operator to confirm the presence of the user via a GPS tracking function that tracks the location of the user when participating in training or testing. The user's electronic device may be registered with the Operator before testing and/or training. The GPS location of the user may also be utilized to determine whether the user's location is close enough to accurate evaluate opacity. And, whether the user's answers are affected by the user's proximity to the smoke stack. Also, this allows the Operator to confirm that a particular user is actually at the test. A user may be required to register their electronic device with the method prior to training or testing. If a different electronic device is utilized by a user, then the Operator will be alerted.

When a user touches the “Slide Finger Here” bubble, an opacity scale appears at step 124. The opacity scale may include all numbers from 0 to 100 that are divisible by 5. EPA method 9 testing provides that a user identify smoke opacity in increments of 5 percent with transparent defined as “0” percent and opaque defined as “100” percent. 50% transparent and 50% opaque would be defined as “50”.

In order to demonstrate sufficient reliability with Method 9 observations and to be field certified, a user must not have an error in excess of 15 percent on a single test point and an average error rate within 7.5 percent for the test. The method herein may include an opacity scale within the “Slide Finger Here” bubble within a range of 15 percent. For example, an opacity scale of “0” to “15” may be displayed within the “Slide Finger Here” bubble. Alternately, the “Slide Finger Here” bubble may display “35”, “40”, “45”, “50”, “55”, “60”, and “65” as a bar for a single test point. The scale may have the opacity number printed larger. So for the example displaying “35” through “65”, the “50” reading may be magnified.

The user waits for the Operator to indicate that the test point is ready to “read” at step 126. The user then evaluates the opacity level of the smoke generated from the smoke generator and selects the opacity value on the “Slide Finger Here” bubble or icon by sliding the number bar left or right as required to select the opacity level observed.

At step 128, the user may press a record button on the screen of the electronic device to record the user's estimation of opacity level. The user's recorded value is then transmitted via internet to the server so that the value can be compared to the value entered by the Operator. The Operator is then able to monitor the answers of each user in real time so that he can address any issues the students may have with viewing the smoke plume. A timing function may be included so that a user only has a certain amount of time to record his answer following emission of the smoke plume. This allows each individual answer to be timed.

The server may transmit via internet to the user's electronic device feedback to indicate the recording of the user's answer at step 130. Steps 120 through 130 are repeated until the user is tested on twenty-five test points utilizing white smoke and twenty-five test points utilizing black smoke. EPA method 9 requires that the user must not have an error not to exceed 7.5 percent for the twenty-five white smoke test points and for the twenty-five black smoke test points.

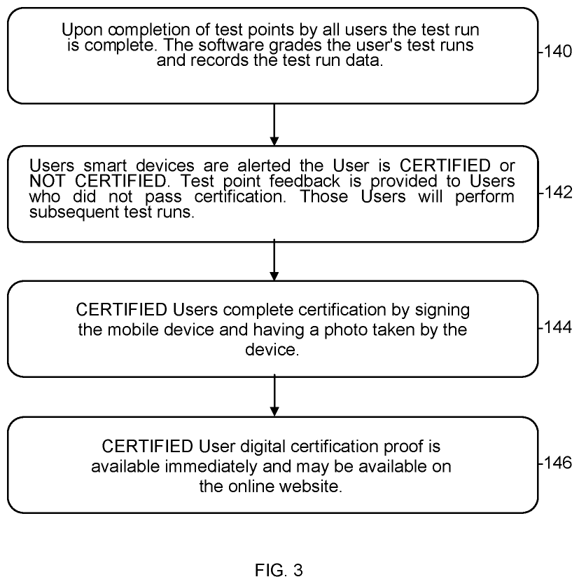

FIG. 3 is a flow chart illustrating validation and certification of user field certification data. At step 140, user answers for completed test points is graded by software. The user's correct answers, error rate, and largest error are recorded and analyzed to see if EPA method 9 certification is proper.

The user's electronic device is immediately alerted whether the user has been field certified at step 142. Feedback for each test point is provided to the user. Feedback may include a photo of the smoke generated by the smoke generator and the user's selected opacity level. This feedback allows a user to improved his or her understanding of smoke opacity, trains them for future field certification testing, and improves the quality of smoke observers.

If a user is field certified, then they complete the certification process via their electronic device at step 144. This may include the user signing the mobile device certifying that they successfully completed the test. Additionally, the user may be required to take his or her current photo and upload said photo onto the server via internet.

At step 146, user data for users field certified may be immediately uploaded by the server onto the EPA method 9 field certification website allowing the user to immediately receive EPA certification.

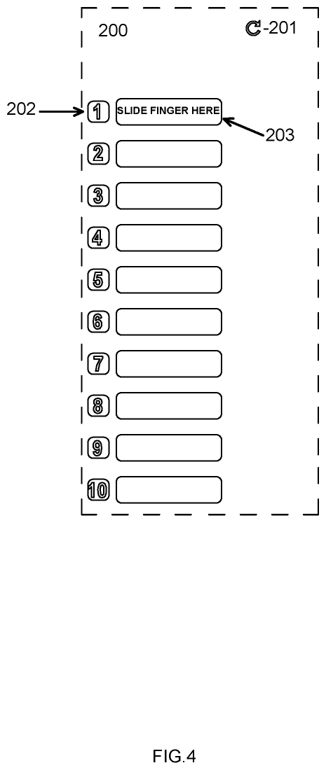

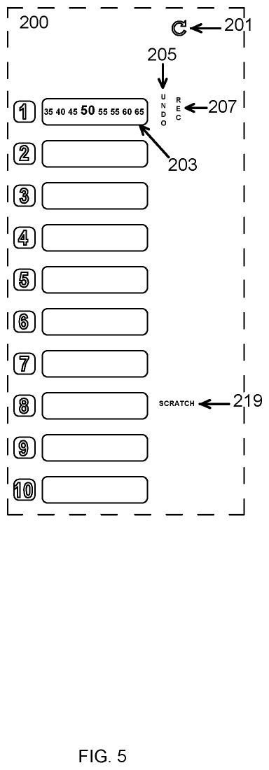

FIG. 4 illustrates s screen shot of screen 200 shot of the user's electronic device at step 122. “Slide Finger Here” is displayed in button 203 is depicted for the first test point 202, which is marked by a “1” in a bubble. Reset button 201 allows a user to reset his test when needed or to abort the test completely so that the user's data is not uploaded to the server.

FIG. 5 illustrates a screen shot of screen 200 of the user's electronic device at step 124. Also shown are “UNDO” screen icon 205 that allows a user to change his answer, “REC” screen icon 207 that a user touches to record his answer to a test point. Button 203 is displaying “35, 40, 45, 50, 55, 60, 65” with the “50” larger than the other numbers. Button 203 is displaying “50” as the user's answer.

Scratch icon 219 allows a user to stop the test. Once a user manipulates the scratch icon 219, the test may be stopped and the Operator may re-show the same point to just the user manipulating scratch icon 219, or the Operator may undo the point entirely and re-show the point for all users in the field being tested. Scratch icon 219 allows a user to undo the last entered answer so that the answer is deleted allowing the user to then repeat the point upon the Operator re-showing the point. Alternatively, upon the Operator re-showing the point, the user can retain the previously recorded answer. This allows a user to redo a test point if, for example, the user is unable to visualize the opacity level due to wind or other factor. If the scratch icon 219 is selected, the Operator will be notified so that a 51^{st} test point can be produced and the user's electronic device will track the alternate smoke test point if said test point is produced.

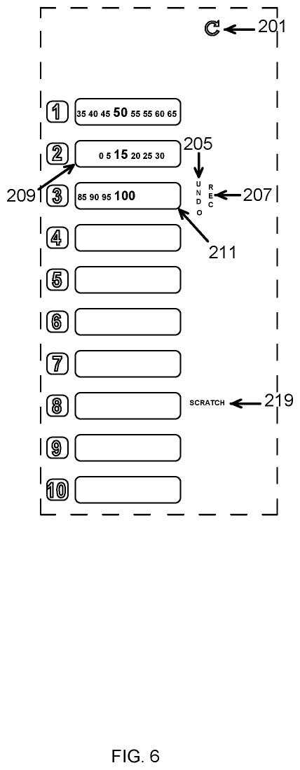

A screen shot of screen 200 at test point 3 is shown in FIG. 6. The answer for test point 2 is shown in button 209, and the answer for test point 3 is shown in button 211. “UNDO” 205, “REC” 207, and “SCRATCH” 219 are shown.

The method herein comprising steps 120 through step 140 is depicted in Tables 1, 2, and 3, below. See FIGS. 2 and 3. All incoming data from the Operator and the User is analyzed and processed by the method. The data may be assembled into one or more tables for analysis and processing.

TABLE 1
Test points 1 through 19 for a user participating in three separate test runs.

| I | 1 | 2 | 3 | 4 | 5 | 6 | 7 | 8 | 9 | 10 | 11 | 12 | 13 | 14 | 15 | 16 | 17 | 18 | 19 |
|---|---|---|---|---|---|---|---|---|---|---|---|---|---|---|---|---|---|---|---|
| Run | 150 | 60 | 70 | 75 | 85 | 95 | 100 | 25 | 20 | 10 | 0 | 25 | 25 | 15 | 20 | 25 | 30 | 25 | 25 |
| A | | | | | | | | | | | | | | | | | | | |
| B | 50 | 60 | 70 | 80 | 90 | 95 | 100 | 25 | 15 | 5 | 0 | 30 | 20 | 10 | 5 | 15 | 25 | 20 | 10 |
| Run | 250 | 60 | 70 | 80 | 90 | 100 | 100 | 15 | 0 | 20 | 30 | 25 | 15 | 0 | 10 | 25 | 100 | 0 | 25 |
| A | | | | | | | | | | | | | | | | | | | |
| B | 50 | 50 | 70 | 80 | 90 | 95 | 100 | 5 | 0 | 10 | 30 | 20 | 10 | 0 | 5 | 15 | 100 | 0 | 30 |
| Run | 350 | 60 | 70 | 80 | 90 | 95 | 100 | 25 | 15 | 10 | 0 | 5 | 30 | 20 | 15 | 5 | 10 | 0 | 10 |
| A | | | | | | | | | | | | | | | | | | | |

Table 1, above, depicts sample data for a user that has completed two separate tests: Run 1 and Run 2, and has yet to enter answers for Run 3. The top row of the table, Row I, shows each test point from test point 1 through test point 19. Run 1 comprises two rows: A and B. Row A of Run 1 shows the correct answer for each test point. The correct answer depicted in Row A for test points 1 through 19 is shown in bold script. Row B of Run 1 depicts the user's answer for test points 1 through 19. The Operator at step 120 activates a test point, which is recorded in Row A. At step 128, the user records his answer, which is depicted in Row B. The method compares the Operator input in Row A to the User input in Row B for each test point. If any User input at Row B is more than 15% different from the Operator input at Row A, the user fails the certification test. Additionally, the method compares each Operator input in Row A to each User input at Row B to determine the difference between each input for each test point. The difference between each input is analyzed to ensure that the average error of the User input at Row B does not deviate from the Operator input at Row A by more than 7.5 percent.

TABLE 2
Test points 20 through 38 for a user participating in three separate test runs.

| I | 20 | 21 | 22 | 23 | 24 | 25 | 26 | 27 | 28 | 29 | 30 | 31 | 32 | 33 | 34 | 35 | 36 | 37 | 38 |
|---|---|---|---|---|---|---|---|---|---|---|---|---|---|---|---|---|---|---|---|
| Run 1 | 30 | 5 | 0 | 100 | 25 | 0 | 50 | 60 | 70 | 80 | 90 | 100 | 0 | 40 | 30 | 20 | 15 | 25 | 25 |
| A | | | | | | | | | | | | | | | | | | | |
| B | 15 | 5 | 0 | 100 | 15 | 0 | 50 | 60 | 70 | 80 | 90 | 100 | 5 | 30 | 20 | 10 | 5 | 15 | 25 |
| Run 2 | 25 | 15 | 0 | 10 | 20 | 10 | 60 | 60 | 70 | 80 | 100 | 0 | 20 | 30 | 25 | 20 | 0 | 25 | 25 |
| A | | | | | | | | | | | | | | | | | | | |
| B | 20 | 10 | 0 | 5 | 25 | 10 | 50 | 65 | 75 | 85 | 100 | 5 | 25 | 20 | 10 | 15 | 5 | 15 | 20 |
| Run 3 | 100 | 10 | 5 | 25 | 15 | 20 | 10 | 5 | 15 | 100 | 5 | 25 | 15 | 10 | 25 | 15 | 20 | 10 | 5 |
| A | | | | | | | | | | | | | | | | | | | |

Table 2, above, depicts sample data for a user that has completed two separate tests: Run 1 and Run 2, and has yet to enter answers for Run 3. The top row of the table, Row I, shows each test point from test point 20 through test point 38. Run 1 comprises two rows: A and B. Row A of Run 1 shows the correct answer for each test point. The correct answer depicted in Row A for test points 20 through 38 is shown in bold script. Row B of Run 1 depicts the user's answer for test points 20 through 38. As noted above, the Operator at step 120 activates a test point, which is recorded in Row A. At step 128, the user records his answer, which is depicted in Row B. This method compares the Operator input in Row A to the User input in Row B for each test point. If any User input at Row B is more than 15% different from the Operator input for all test points at Row A, the user fails the certification test. Additionally, the method compares each Operator input in Row A to each User input at Row B to determine the difference between each input for each test point. The difference between each input is analyzed to ensure that the average error of the User input at Row B does not deviate from the Operator input at Row A by more than 7.5 percent.

TABLE 3
Test points 39 through 50 for a user participating
in three separate test runs.

| I | 39 | 40 | 41 | 42 | 43 | 44 | 45 | 46 | 47 | 48 | 49 | 50 | Pass/Fail |
|---|---|---|---|---|---|---|---|---|---|---|---|---|---|
| Run 1 | 40 | 10 | 15 | 10 | 100 | 0 | 25 | 35 | 30 | 20 | 100 | 0 | |
| A | | | | | | | | | | | | | |
| B | 20 | 10 | 15 | 5 | 100 | 5 | 15 | 25 | 20 | 10 | 100 | 5 | Fail |
| Run 2 | 20 | 100 | 0 | 20 | 25 | 20 | 20 | 15 | 0 | 100 | 15 | 0 | |
| A | | | | | | | | | | | | | |
| B | 25 | 100 | 5 | 10 | 25 | 20 | 15 | 10 | 5 | 100 | 10 | 5 | Pass |
| Run 3 | 15 | 100 | 5 | 25 | 15 | 10 | 5 | 100 | 5 | 25 | 10 | 5 | Not |
| A | | | | | | | | | | | | | Completed |

Table 3, above, depicts test points 39 through 50. The software grade for the User's test run at Step 140 is depicted in the Pass/Fail Column. For Run 1 above, the User's answer entered at Row B for test point 39 is 20, which differs more than 15 percent from the Operator entered value of 40 at Row A. The User's answer at test point 39 is shown in bold italic print in a larger font on Table 3. The Pass/Fail column reflects that the User failed Run 1 due to the answer at test point 39. The failed test is immediately transmitted to the User allowing the User to immediately be retested.

The User's answers to each test point 1 through 50 is processed at step 140. None of the answers in Row B for Run 2 differ from the Operator-entered data at Row A by more than 15 percent, and the average difference between all answers in Row B and all Operator-entered data at Row A is less than 7.5 percent. The Pass/Fail column indicates that the User has successfully completed Run 2. This is immediately transmitted to the User and to the EPA. This allows the User to complete all field certification testing immediately.

The method herein may alter the table so that a user's correct answer is shown in Green, any answer 5 percent off is shown in olive, any answer 10 percent off is shown in tan, any user answer 15 percent off is shown in orange, and any user answer more than 15 percent incorrect is shown in red. Any method of color coding may be used to assist the user and the Operator in identifying the scoring system.

This method may allow a summary of the user's performance to be generated and sent to the user. For example, if a user is having issues with opacity levels near 100 percent, then the user may be provided a summary and future training at or near the 100 percent opacity level. This method allows training and/or testing to be customized to the individual user to maximize the individual user's learning and comprehension.

I hereby claim:

1. A method of smoke opacity field testing comprising:
an operator with an electronic device with internet access,
an user with an electronic device with internet access,
a server that accepts data from the operator and accepts data from the user,
a computer,
wherein the computer receives data from the server that the server received from the operator, wherein the computer enters the data from the server that the server received from the operator on a table generated by the computer, wherein the data from the server that the server received from the operator is a number between 0 and 100,
wherein the computer receives data from the server that the server received from the user, wherein the computer enters the data from the server that the server received from the user on the table generated by the computer, wherein the data from the server that the server received from the operator is a number between 0 and 100,
wherein the computer processes the data entered onto the table by comparing the number that the server received from the operator with the number that the server received from the user, wherein the computer processing generates a first processed data and a second processed data,
wherein the computer transmits first processed data to the server and the server transmits the first processed data to the operator, and
wherein the computer transmits second processed data to the server and the server transmits the second processed data to the user.

2. The method of claim 1 wherein the computer processes data from the server that the server received from the operator and data from the server that the server received from the user for fifty separate test points.

2. The method of claim 2, wherein the number the computer received from the user is not 15 more than or 15 less than the number the computer received from the operator.

4. The method of claim 2, wherein the average difference between the number the computer received from the user and the number the computer received from the operator is less than 7.5 percent for each of fifty separate test points.

5. The method of claim 2, wherein the number the computer received from the user is not 15 more than or 15 less than the number the computer received from the operator, and wherein the average difference between the number the computer received from the user and the number the computer received from the operator is less than 7.5 percent for all fifty separate test points.

6. The method of claim 2, wherein the method tracks the location of the user via GPS.

7. The method of claim 6, wherein the method compares the location of the user via GPS to the location of a smoke stack.

8. The method of claim 7, wherein the computer compares the number received by the user with the number received from the operator to calibrate the number received from the operator to factor in the location of the user via GPS to the location of the smoke stack.

9. The method of claim 2, wherein the computer compares the number received by the user with the number received from the operator to calibrate the number received from the operator to factor into the calibrated number temperature, wind direction, haze, fog, and overcast skies.

10. The method of claim 1, wherein the method requires the user to take a picture of himself with the electronic device.

11. The method of claim 1, wherein the method allows the operator to limit the time that the server accepts data from the user.

12. The method of claim 11, wherein the method alerts the operator if the user fails to enter data within the time that the server accepts data from the user.

13. The method of claim 1, wherein the user is allowed to stop the smoke opacity field testing method.

14. The method of claim 1, wherein the user is allowed to repeat one of the fifty separate test points.

15. A method of smoke opacity field training comprising:
an operator with an electronic device with internet access,
an user with an electronic device with internet access,
a server that accepts data from the operator and accepts data from the user,
a computer,
wherein the computer receives data from the server that the server received from the operator, wherein the computer enters the data from the server that the server received from the operator on a table generated by the computer, wherein the data from the server that the server received from the operator is a number between 0 and 100,
wherein the computer receives data from the server that the server received from the user, wherein the computer enters the data from the server that the server received from the user on the table generated by the computer, wherein the data from the server that the server received from the operator is a number between 0 and 100,
wherein the computer processes the data entered onto the table by comparing the number that the server received from the operator with the number that the server received from the user, wherein the computer processing generates a first processed data and a second processed data,
wherein the computer transmits first processed data to the server and the server transmits the first processed data to the operator, and
wherein the computer transmits second processed data to the server and the server transmits the second processed data to the user.

16. The method of claim 15, wherein the computer processes data from the server that the server received from the operator and data from the server that the server received from the user for fifty separate test points.

17. The method of claim 15, wherein the number the computer received from the user is not 15 more than or 15 less than the number the computer received from the operator.

18. The method of claim 15, wherein the average difference between the number the computer received from the user and the number the computer received from the operator is less than 7.5 percent for each of fifty separate test points.
